(19) United States
(12) Patent Application Publication
(10) Pub. No.: US 2003/0009558 A1
(43) Pub. Date: Jan. 9, 2003

(54) Scalable server clustering

(76) Inventor: Doron Ben-Yehezkel, Newport Beach, CA (US)

Correspondence Address: J. D. Harriman II, COUDERT BROTHERS, 23rd Floor, 333 South Hope Street, Los Angeles, CA, 90071, US

(21) Appl. No.: 09/898,589

(22) Filed: Jul. 3, 2001

(51) Int. Cl. G06F 15/173

(52) U.S. Cl. 709/225; 709/226

(57) ABSTRACT

The present invention provides a method and apparatus for scalable server clustering. In one embodiment, a plurality of servers service client requests. In one embodiment, responsibility for servicing a client is assigned to a primary server. Requests from the client are routed to the primary server. In one embodiment, the primary server is selected for a client using a round-robin method. In another embodiment, a server monitors how many clients it serves as a primary server. If a client is to be assigned a server as a primary server and the server determines that it is assigned to a sufficient number of clients, the server can select a different server to serve as the client's primary server. In one embodiment, an alternate server is assigned to the client. If the primary server is unavailable, the alternate server becomes the primary server and a new alternate server is selected.

### BACKGROUND OF THE INVENTION

1. Field of the Invention

The present invention relates to the field of client/server systems, and in particular to a method and apparatus for scalable server clustering.

2. Background Art

In typical client/server systems, one server is responsible for servicing client requests. Multiple clients send requests to the server and the server addresses each client's needs. However, as the number of clients increases, the server becomes overloaded. In prior art methods, there is no cost effective way to handle this problem. This problem can be better understood by a review of client/server systems.

### Client/Server Systems

In client/server systems, a client sends requests for service to a server. The server receives the requests of many clients and services these requests. The speed of the server limits the number of clients the server can service at one time. As the number of clients increases, the number client requests increases beyond the server's ability to service requests. Thus, a server which was previously able to service the system's client traffic becomes unable to service the system's client traffic when the number of clients increases.

For example, a server which can service 10,000 simultaneous client requests is able to service the demands of a system in which the number of simultaneous requests never exceeds 9,000. However, if enough clients are added to the system that the number of simultaneous requests regularly exceeds 20,000, the server will not be able to service the demands of the system without loss in system performance.

In one prior art method, a more powerful server is installed when a server is no longer able to service the requests of the system. In the above example, a server which can service 100,000 simultaneous client requests replaces the original server. However, installing a more powerful server is sometimes prohibitively expensive.

### SUMMARY OF THE INVENTION

The present invention provides a method and apparatus for scalable server clustering. In one embodiment of the present invention, a plurality of servers service client requests. In one embodiment, responsibility for servicing a client is assigned to a primary server. Requests from the client are routed to the primary server. In one embodiment, the primary server is selected for a client using a round-robin method. Servers are ordered, and when a client with no assigned primary server makes a request, the next server in the order is selected as the primary server.

In one embodiment, a server monitors how many clients it serves as a primary server. If a client is to be assigned a server as a primary server and the server determines that it is assigned to a sufficient number of clients, the server can select a different server to serve as the client's primary server. When a server refuses a client and selects another server as the client's primary server, it is termed “bouncing” the client. In one embodiment, when a client is bounced to a server, that server cannot bounce the client again and must serve as the client's primary server. In one embodiment, each server transmits its status to every other server. A server's status includes how many clients it serves as a primary server, how many clients it serves as a secondary server and the total number of clients it is able to serve. Servers use the status of other servers in selecting alternate servers and in selecting a server to receive a bounced client.

In one embodiment, an alternate server is assigned to the client. If the primary server is unavailable, the alternate server becomes the primary server and a new alternate server is selected. In one embodiment, clients maintain a cache of data. The primary and alternate servers both store a copy, or mirror, of the client's cache. Thus, if a client is unsure of the correctness of a data item, it can request the data item from its primary server. The primary server retrieves the information and compares it to the information it has stored as that client's cache. If the data is the same, the server instructs the client to use the data it already has in its cache.

In one embodiment, if the primary server does not have the client's cache in its memory, the client computes a value from its cache using a cyclic redundancy code and sends the value to the primary server. The primary server retrieves the data and uses it to compute a value using a cyclic redundancy code. If the two values are identical, the primary server instructs the client to use the data it already has in its cache.

### BRIEF DESCRIPTION OF THE DRAWINGS

These and other features, aspects and advantages of the present invention will become better understood with regard to the following description, appended claims and accompanying drawings where:

FIG. 1 is a flow diagram of the process of servicing client requests in accordance with one embodiment of the present invention.

FIG. 2 is a flow diagram of the process of selecting a primary server in accordance with one embodiment of the present invention.

FIG. 3 is a flow diagram of the process of selecting a primary server in accordance with one embodiment of the present invention.

FIG. 4 is a flow diagram of the process of selecting a primary server in accordance with one embodiment of the present invention.

FIG. 5 is a flow diagram of the process of selecting an alternate server in accordance with one embodiment of the present invention.

FIG. 6 is a flow diagram of the process of servicing a client request in accordance with the present invention.

FIG. 7 is a flow diagram of the process of client service maintenance in accordance with one embodiment of the present invention.

FIG. 8 is a block diagram of a server cluster in accordance with one embodiment of the present invention.

FIG. 9 is a flow diagram of the process of servicing a client request in accordance with one embodiment of the present invention.

FIG. 10 is a flow diagram of the process of servicing a client request in accordance with one embodiment of the present invention.

FIG. 11 is a flow diagram of the process of increasing the capacity of a server cluster in accordance with one embodiment of the present invention.

### DETAILED DESCRIPTION OF THE INVENTION

The invention is a method and apparatus for scalable server clustering. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

### Server Clusters

In one embodiment of the present invention, a plurality of servers service client requests. In one embodiment, responsibility for servicing a particular client is assigned to a primary server. Requests from the client are routed to the primary server. In one embodiment, servers share one address (e.g., a domain name) but have different individual addresses (e.g., an IP address). A client addresses a server through the shared address. If the client is not already assigned a primary server, the client is assigned a primary server. If the client is assigned to a primary server, the client's requests are routed to that server. In one embodiment, the client is unaware that there is more than one server.

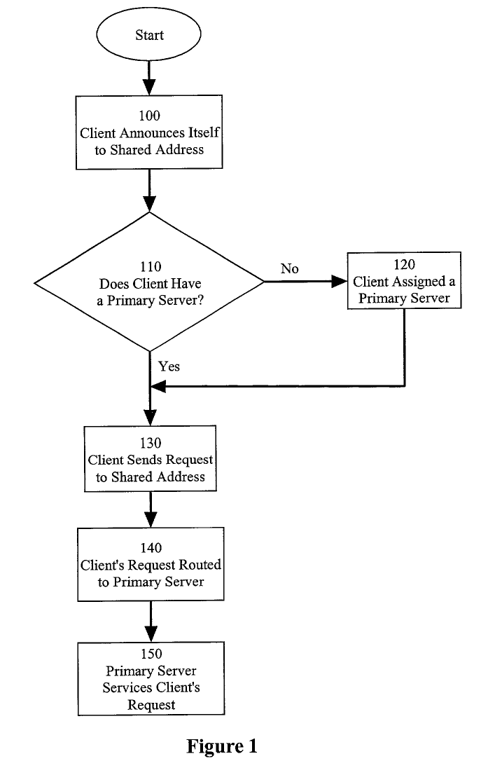

FIG. 1 illustrates the process of servicing client requests in accordance with one embodiment of the present invention. At step 100, a client announces itself to the shared address. At step 110, it is determined whether the client has a primary server. In one embodiment, each server knows which clients are assigned to the other servers. Thus, the server accessed by announcing to the shared address knows which server, if any, is responsible for servicing the client. If the client does not have a primary server, at step 120, the client is assigned a primary server and the process continues at step 130. If the client has a primary server, at step 130, the client sends a request to the shared address. At step 140, the client's request is routed to the primary server. At step 150, the primary server services the client's request.

### Primary Server Selection

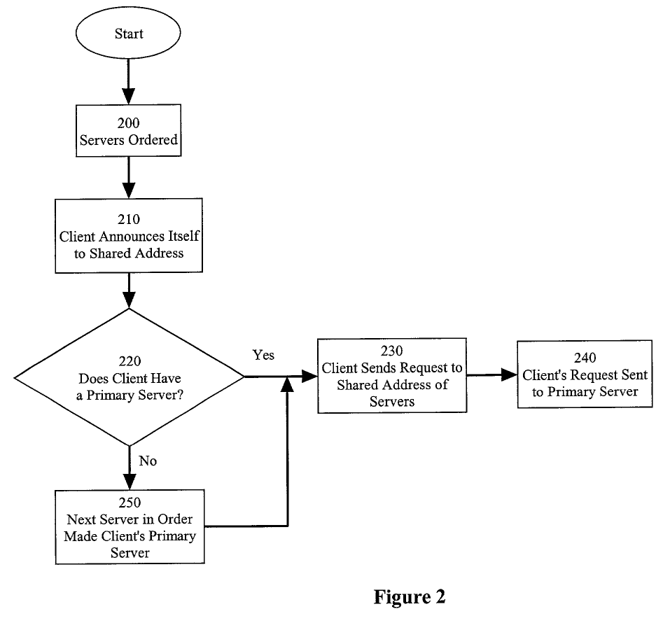

In one embodiment, the primary server is selected for a client using a round-robin method. Servers are ordered, and when a client with no assigned primary server makes a request, the next server in the order is selected as the primary server. FIG. 2 illustrates the process of selecting a primary server in accordance with one embodiment of the present invention. At step 200, the servers are ordered. At step 210, a client announces itself to the shared address. At step 220, it is determined whether the client has a primary server. If the client has a primary server, at step 230, the client sends a request to the shared address of the servers. At step 240, the client's request is sent to the primary server. If the client does not have a primary server, at step 250, the next server in the order is made the client's primary server and the process continues at step 230.

In one embodiment, a server monitors how many clients it serves as a primary server. If a client is to be assigned a server as a primary server and the server determines that it is assigned to a sufficient number of clients, the server can select a different server to serve as the client's primary server. When a server refuses a client and selects another server as the client's primary server, it is termed “bouncing” the client. In one embodiment, when a client is bounced to a server, that server cannot bounce the client again and must serve as the client's primary server. In other embodiments, a client can be bounced more than once.

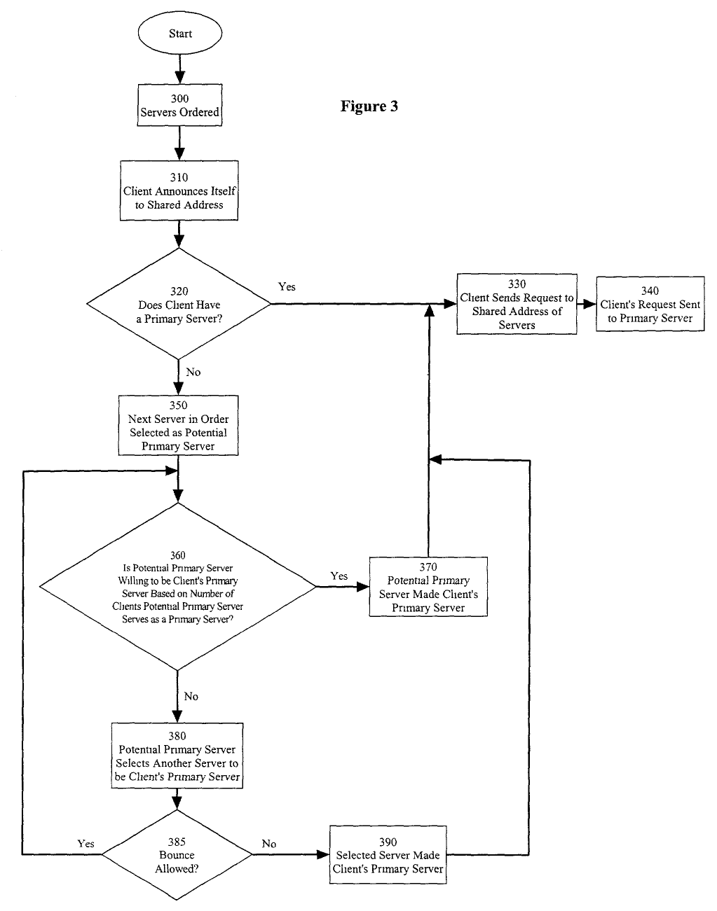

FIG. 3 illustrates the process of selecting a primary server in accordance with one embodiment of the present invention. At step 300, the servers are ordered. At step 310, a client announces itself to the shared address. At step 320, it is determined whether the client has a primary server. If the client has a primary server, at step 330, the client sends a request to the shared address of the servers. At step 340, the client's request is sent to the primary server. If the client does not have a primary server, at step 350, the next server in the order is selected as a potential primary server.

At step 360, it is determined whether the potential primary server is willing to be the client's primary server based on the number of clients the potential primary server serves as a primary server. If the potential primary server is willing to be the client's primary server, at step 370, the potential primary server is made the client's primary server and the process continues at step 330. If the potential primary server is not willing to be the client's primary server, at step 380, the potential primary server selects another server to be the client's primary server.

At step 385, it is determined whether the selected server can bounce the client. If the selected server cannot bounce the client, the process repeats at step 360. If the selected server cannot bounce the client, at step 390, the other server is made the client's primary server and the process continues at step 330.

In one embodiment, each client is also assigned an alternate server. The alternate server is used when the primary server is unavailable. In one embodiment, each server transmits its status to every other server. In one embodiment, a server's status includes how many clients it serves as a primary server, how many clients it serves as an alternate server, if any, and the total number of clients it is able to serve. Servers use the status of other servers in selecting alternate servers and in selecting a server to receive a bounced client. In one embodiment, the status messages between servers are sent via a management backplane. In one embodiment, the copies of the client's cache on the primary and alternate servers are synchronized via the management backplane. In one embodiment, synchronization takes place when the client logs off from the server. In another embodiment, synchronization takes place after a specific number of transactions. In yet another embodiment, synchronization takes place after each transaction.

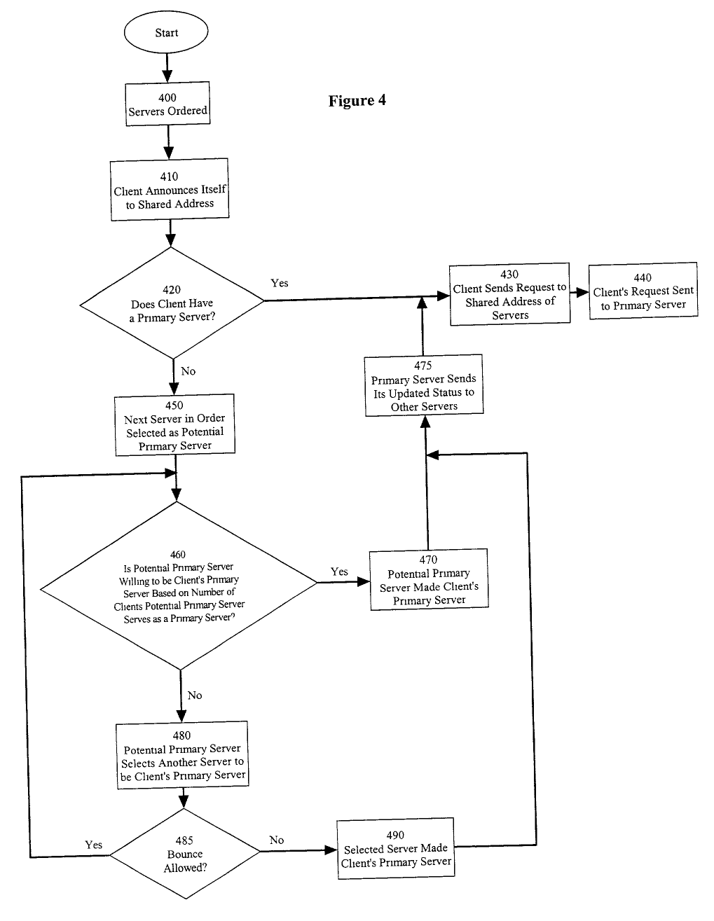

FIG. 4 illustrates the process of selecting a primary server in accordance with one embodiment of the present invention. At step 400, the servers are ordered. At step 410, a client announces itself to the shared address. At step 420, it is determined whether the client has a primary server. If the client has a primary server, at step 430, the client sends a request to the shared address of the servers. At step 440, the client's request is sent to the primary server. If the client does not have a primary server, at step 450, the next server in the order is selected as a potential primary server.

At step 460, it is determined whether the potential primary server is willing to be the client's primary server based on the number of clients the potential primary server serves as a primary server. If the potential primary server is willing to be the client's primary server, at step 470, the potential primary server is made the client's primary server. At step 475, the primary server sends its updates status to the other servers and the process continues at step 430. If the potential primary server is not willing to be the client's primary server, at step 480, the potential primary server selects another server to be the client's primary server. In one embodiment, the new potential primary server is selected by examining the status of the other servers and selecting the server with the lowest ratio of the number of clients the server serves as a primary server to the total number of clients the server can serve. In other embodiments, other methods of evenly distributing the workload are used to select the new potential primary server.

At step 485, it is determined whether the selected server can bounce the client. If the selected server can bounce the client, the process repeats at step 460. If the selected server cannot bounce the client, at step 490, the other server is made the client's primary server and the process continues at step 475.

### Alternate Server Selection

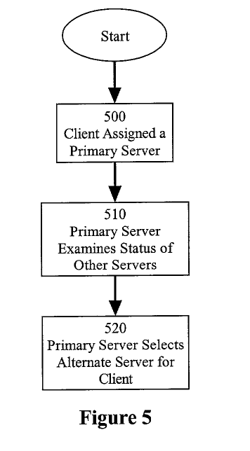

In one embodiment, an alternate server is assigned to the client. If the primary server is unavailable, the alternate server becomes the primary server and a new alternate server is selected. FIG. 5 illustrates the process of selecting an alternate server in accordance with one embodiment of the present invention. At step 500, the client is assigned a primary server. At step 510, the primary server examines the status of the other servers. At step 520, the primary server selects an alternate server for the client.

In one embodiment, the alternate server is selected by examining the status of the other servers and selecting the server with the lowest ratio of the number of clients the server serves as a primary server to the total number of clients the server can serve. In other embodiments, other methods of evenly distributing the workload are used to select the new potential primary server.

In one embodiment, the primary server sends a message directly to the alternate server notifying it that it was selected as the alternate server. In another embodiment, the information that the alternate server was selected is sent out as part of the primary server's status message. Thus, all servers are notified that the alternate server is assigned to the client.

### Servicing Client Requests

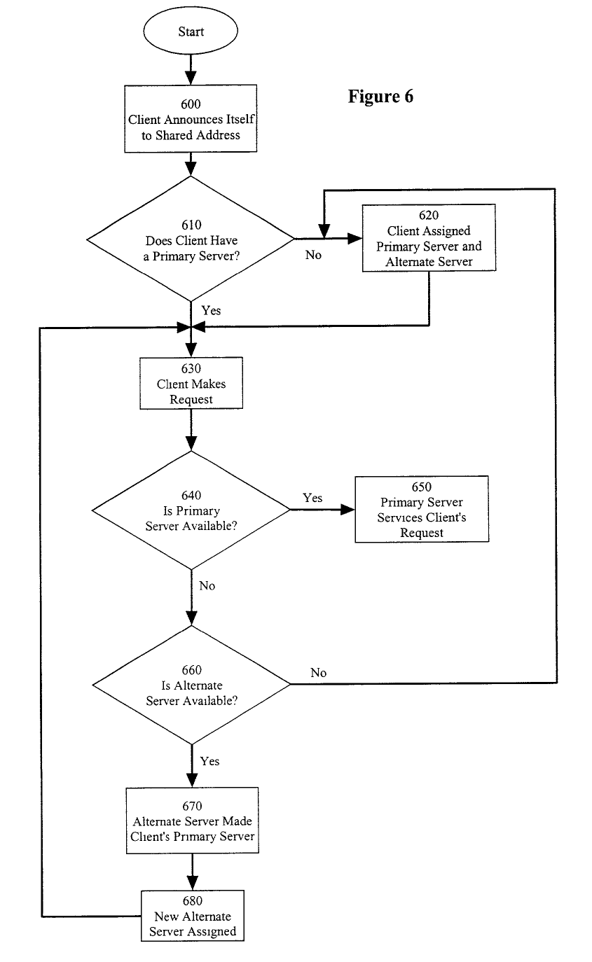

FIG. 6 illustrates the process of servicing a client request in accordance with the present invention. At step 600, a client announces itself to the shared address. At step 610, it is determined whether the client has a primary server. If the client does not have a primary server, at step 620, the client is assigned to a primary server and alternate server and the process continues at step 630. If the client has a primary server, at step 630, client sends a request to the shared address of the servers. At step 640, it is determined whether the primary server is available. The primary server is unavailable when the server is turned off, disconnected from the system for maintenance or otherwise made unable to communicate with the client. Additionally, if the primary server is servicing a sufficiently large number of requests (e.g., 80% of the primary server's capacity), it determines that it is unavailable to handle new requests and the request is bounced to the alternate server. The primary server may also determine it is unavailable due to other criteria.

If the primary server is available, at step 650, the primary server services the client's request. If the primary server is not available, at step 660, it is determined whether the alternate server is available. The alternate server may be unavailable for the same reasons as the primary server. If the alternate server is not available, the process continues at step 620. If the alternate server is available, at step 670, the alternate server is made the client's primary server. At step 680, a new alternate server is assigned and the process continues at step 630.

When a server is unavailable, a client's primary server may switch from the unavailable server to another server. Thus, in one embodiment, part of the status a server sends to other servers is the identity of clients it serves as a primary server. When a server becomes available, it checks to see if any of the clients it serves as a primary server have another server as the primary server and adjusts its status accordingly.

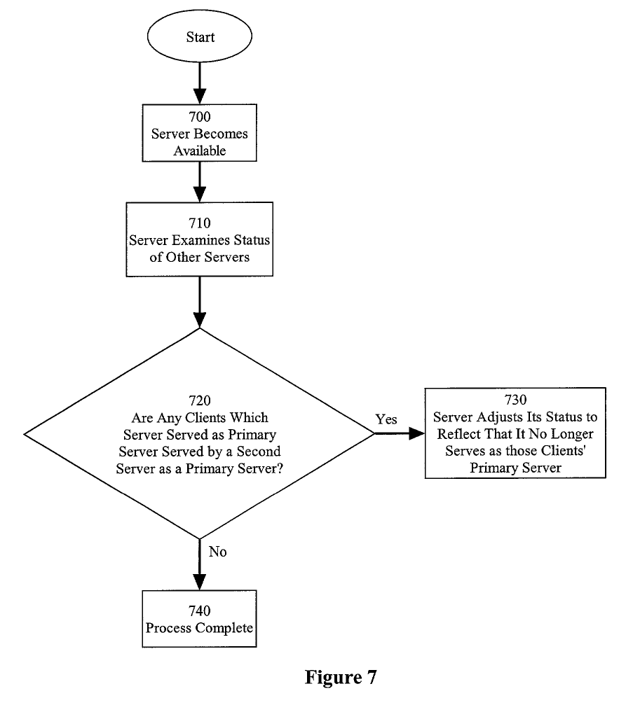

FIG. 7 illustrates the process of client service maintenance in accordance with one embodiment of the present invention. At step 700, a server becomes available. At step 710, the server examines the status of the other servers. At step 720, it is determined whether any client which the server served as a primary server are served by a second server as a primary server. If a client which the server served as a primary server is served by a second server as a primary server, at step 730, the server adjusts its status to reflect that it no longer serves as those clients' primary server. If no client which the server served as a primary server is served by a second server as a primary server, at step 740, the process is complete.

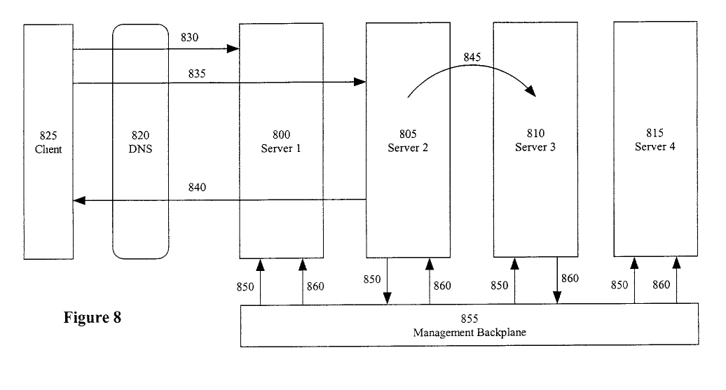

FIG. 8 illustrates a server cluster in accordance with one embodiment of the present invention. The cluster is comprised of Servers 1 (800), 2 (805), 3 (810) and 4 (815). Each server has its own IP address, but they all share the same domain name in the DNS (820). In FIG. 8, a client (825) sends a request (830) to its primary server, Server 1. Server 1 is unavailable, so the client sends its request (835) to its alternate server, Server 2. Server 2 services (840) the client's request. Server 2 assigns (845) Server 3 to be the new alternate server. Server 2 broadcasts (850) its new status to the other servers via the management backplane (855). Server 3 broadcasts (860) its new status to the other servers via the management backplane.

### Data Transmission Amount Reduction

When the network between the client and the server is a wireless network, as is the case if the client is on a pager, a cellular phone, a computer using a wireless network or a device communicating with a satellite, it is expensive to transmit data between the server and the client. Thus, it is desirable to reduce the amount of data that is transmitted between the server and the client. One system for reducing the amount of data transmitted between the server and the client that can be used with the present invention is described in co-pending U.S. patent application entitled “Adaptive Transport Protocol” application Ser. No. 09/839,383, filed on Apr. 20, 2001, assigned to the assignee of the present application, and hereby fully incorporated into the present application by reference.

In one embodiment, clients maintain a cache of data. The primary and alternate servers both store a copy, or mirror, of the client's cache. Thus, if a client is unsure of the correctness of a data item, it can request the data item from its primary server. The primary server retrieves the information and compares it to the information it has stored as that client's cache. If the data is the same, the server instructs the client to use the data it already has in its cache. Since the instruction to use the data in the cache is typically smaller than the requested data item, less data is transferred using this embodiment. Thus, when data transfers are expensive (e.g., wireless communications), this embodiment reduces the cost of some data requests.

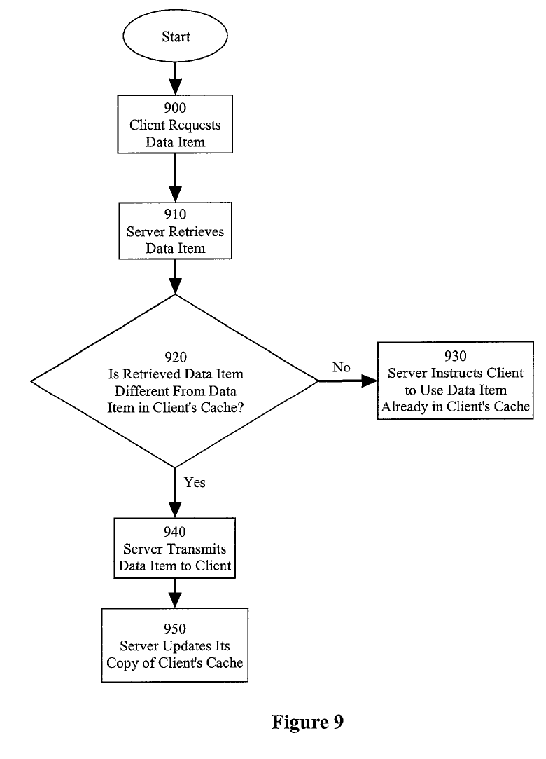

FIG. 9 illustrates the process of servicing a client request in accordance with one embodiment of the present invention. At step 900, a client requests a data item. At step 910, the server retrieves the data item. At step 920, the server determines whether the retrieved data item is different from the data item in the client's cache. If the retrieved data item is not different from the data item in the client's cache, at step 930, the server instructs the client to use the data item already in the client's cache. If the retrieved data item is different from the data item in the client's cache, at step 940, the server transmits the data item to the client. At step 950, the server updates its copy of the client's cache.

In one embodiment, if the primary server does not have the client's cache in its memory, the client computes a value from its cache using a correction method (e.g., a cyclic redundancy code) and sends the value to the primary server. The primary server retrieves the data and uses it to compute a value using the correction method. If the two values are identical, the primary server instructs the client to use the data it already has in its cache. Since the instruction to use the data in the cache is typically smaller than the requested data item, less data is transferred using this embodiment.

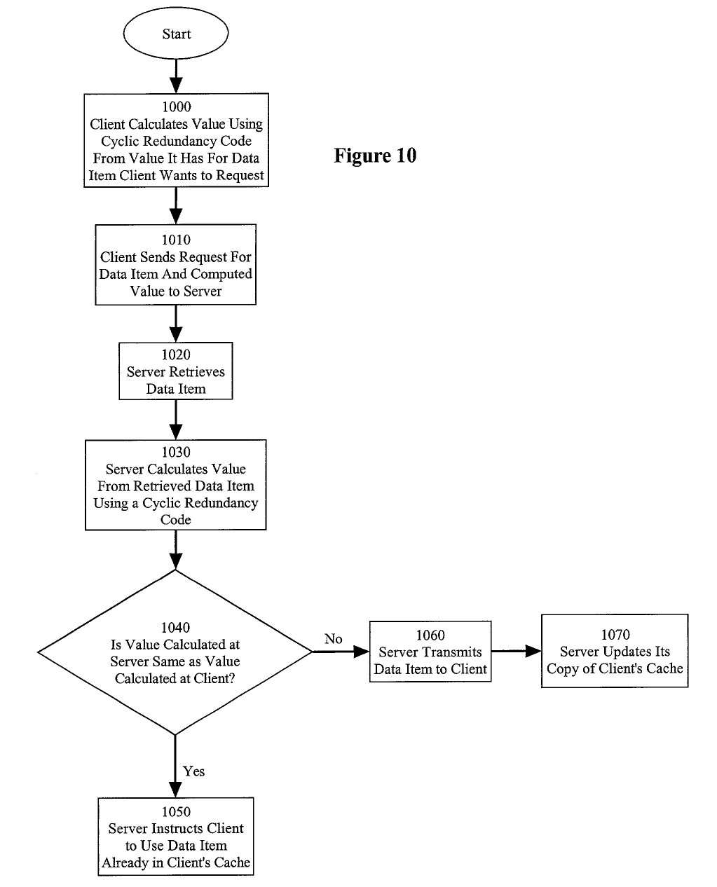

FIG. 10 illustrates the process of servicing a client request when the server does not have a copy of the requested item in its copy of the client's cache in accordance with one embodiment of the present invention. At step 1000, a client calculates a value using a cyclic redundancy code from the value it has for a data item the client wants to request. At step 1010, the client sends the request for the data item and the computed value to the server. At step 1020, the server retrieves the data item.

At step 1030, the server calculates a value from the retrieved data item using a cyclic redundancy code. At step 1040, it is determined whether the value calculated at the server is the same as the value calculated at the client. If the values are the same, at step 1050, the server instructs the client to use the data item already in the client's cache. If the values are not the same, at step 1060, the server transmits the data item to the client. At step 1070, the server updates its copy of the client's cache.

### Expanding Server Clusters

In one embodiment, a new server can be added to the server cluster. Thus, if a server cluster reaches its capacity, a new server is added to the cluster to increase the server cluster's capacity. Servers are not required to have the same properties, so servers with different speeds or memory sizes can operate as part of the same server cluster. Thus, if a server cluster is able to service 10,000 simultaneous client requests and the system demand increases to having 15,000 simultaneous client requests, a new server capable of servicing 5,000 simultaneous client requests is added to the cluster. Adding a server capable of servicing 5,000 simultaneous client requests is more cost effective than switching to a single server which is capable of servicing 15,000 simultaneous client requests as was required by prior art methods.

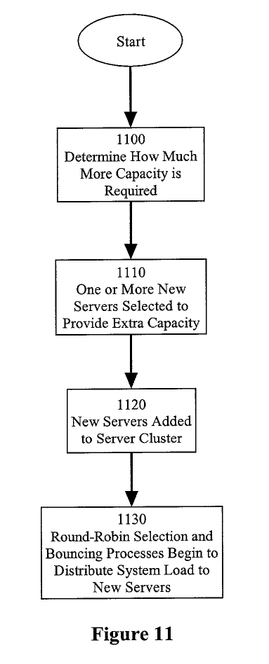

FIG. 11 illustrates the process of increasing the capacity of a server cluster in accordance with one embodiment of the present invention. At step 1100, it is determined how much more capacity is required. At step 1110, one or more new servers are selected to provide the extra capacity. At step 1120, the new servers are added to the server cluster. At step 1130, the round-robin selection and bouncing processes begin to distribute the system load to the new servers.

Thus, a method and apparatus for scalable server clustering is described in conjunction with one or more specific embodiments. The invention is defined by the following claims and their full scope and equivalents.

1. A method for client request servicing comprising:
assigning a primary server from a plurality of servers to a client;
routing a request from said client to said primary server; and
servicing said request with said primary server.

2. The method of claim 1 wherein said step of assigning comprises:
ordering said plurality of servers; and
selecting a next server.

3. The method of claim 1 wherein said step of assigning comprises:
determining a first server;
determining a number of clients said first server is currently serving;
selecting a second server if said number is greater than a threshold for said first server.

4. The method of claim 3 wherein said second server must serve as said primary server.

5. The method of claim 3 wherein said step of selecting comprises:
determining a status of said second server.

6. The method of claim 5 wherein said status comprises:
a first number wherein said first number is the number of clients said second server serves as a first primary server; and
a second number wherein said second number is a client capacity of said second server.

7. The method of claim 5 wherein said status further comprises:
a third number wherein said third number is the number of client said second server serves as an alternate server.

8. The method of claim 5 wherein said step of determining said status comprises:
receiving a plurality of status updates from said plurality of servers.

9. The method of claim 1 further comprising:
assigning an alternate server from said plurality of servers.

10. The method of claim 9 wherein said step of assigning said alternate server is performed by said primary server based on a status of said alternate server.

11. The method of claim 9 further comprising:
reassigning said alternate server as a new primary server and selecting a new alternate server if said primary server becomes unavailable and said client makes a request.

12. The method of claim 11 further comprising:
removing said client from a list of clients served by said primary server.

13. The method of claim 12 wherein said list is maintained in said primary server.

14. The method of claim 13 wherein said step of removing is performed when said primary server becomes available.

15. The method of claim 1 further comprising:
maintaining a first cache of data items on said client; and
mirroring said first cache in a second cache on said primary server.

16. The method of claim 15 further comprising:
mirroring said first cache in a third cache on an alternate server.

17. The method of claim 15 further comprising:
retrieving a first data item from a data source wherein said step of retrieving is accomplished by said primary server; and
instructing said client to use a second data item wherein said second data item is in said first cache if said first data item is equal to a copy of said second data item in said second cache.

18. The method of claim 15 further comprising:
calculating a first value from a first data item using a correction method wherein said first data item is in said first cache;
transmitting said first value from said client to said primary server;
retrieving a second data item;
calculating a second value from said second data item using said correction method; and
instructing said client to use said first data item if said second value is equal to said first value.

19. The method of claim 18 wherein said step of instructing comprises:
storing said second data item in said second cache.

20. The method of claim 18 wherein said correction method is a cyclic redundancy code.

21. A client request servicing system comprising:
an assignment unit configured to assign a primary server from a plurality of servers to a client;
a router configured to route a request from said client to said primary server wherein said primary server is configured to service said request.

22. The client request servicing system of claim 21 wherein said assignment unit comprises:
an ordering unit configured to order said plurality of servers; and
a selection unit configured to select a next server.

23. The client request servicing system of claim 21 wherein said assignment unit comprises:
a first determiner configured to determine a first server;
a second determiner configured to determine a number of clients said first server is currently serving;
a selection unit configured to select a second server if said number is greater than a threshold for said first server.

24. The client request servicing system of claim 23 wherein said second server must serve as said primary server.

25. The client request servicing system of claim 23 wherein said selection unit comprises:
a third determiner configured to determine a status of said second server.

26. The client request servicing system of claim 25 wherein said status comprises:
a first number wherein said first number is the number of clients said second server serves as a first primary server; and
a second number wherein said second number is a client capacity of said second server.

27. The client request servicing system of claim 25 wherein said status further comprises:
a third number wherein said third number is the number of client said second server serves as an alternate server.

28. The client request servicing system of claim 25 wherein said third determiner comprises:
a receiving unit configured to receive a plurality of status updates from said plurality of servers.

29. The client request servicing system of claim 21 further comprising:
a second assignment unit configured to assign an alternate server from said plurality of servers.

30. The client request servicing system of claim 29 wherein said second assignment unit is located in said primary server and is further configured to assign said alternate server based on a status of said alternate server.

31. The client request servicing system of claim 29 further comprising:
a third assignment unit configured to reassign said alternate server as a new primary server and selecting a new alternate server if said primary server becomes unavailable and said client makes a request.

32. The client request servicing system of claim 31 further comprising:
a removal unit configured to remove said client from a list of clients served by said primary server.

33. The client request servicing system of claim 32 wherein said list is maintained in said primary server.

34. The client request servicing system of claim 33 wherein said removal unit is further configured to perform when said primary server becomes available.

35. The client request servicing system of claim 21 further comprising:
a maintenance unit configured to maintain a first cache of data items on said client; and
a mirroring unit configured to mirror said first cache in a second cache on said primary server.

36. The client request servicing system of claim 35 further comprising:
a second mirroring unit configured to mirror said first cache in a third cache on an alternate server.

37. The client request servicing system of claim 35 further comprising:
a retrieval unit configured to retrieve a first data item from a data source wherein said retrieval unit is located in said primary server; and
an instruction unit configured to instruct said client to use a second data item wherein said second data item is in said first cache if said first data item is equal to a copy of said second data item in said second cache.

38. The client request servicing system of claim 35 further comprising:
a calculation unit configured to calculate a first value from a first data item using a correction method wherein said first data item is in said first cache;
a transmitter configured to transmit said first value from said client to said primary server;
a retrieval unit configured to retrieve a second data item from a data source wherein said retrieval unit is located in said primary server;
a second calculation unit configured to calculate a second value from said second data item using said correction method; and
an instruction unit configured to instruct said client to use said first data item if said second value is equal to said first value.

39. The client request servicing system of claim 38 wherein said instruction unit comprises:
a storage unit configured to store said second data item in said second cache.

40. The client request servicing system of claim 38 wherein said correction method is a cyclic redundancy code.

41. A computer program product comprising:
a computer usable medium having computer readable program code embodied therein configured to service a client request, said computer program product comprising:
computer readable code configured to cause a computer to assign a primary server from a plurality of servers to a client;
computer readable code configured to cause a computer to route said client request from said client to said primary server wherein said primary server is configured to service said client request.

42. The computer program product of claim 41 wherein said assignment unit comprises:
computer readable code configured to cause a computer to order said plurality of servers; and
computer readable code configured to cause a computer to select a next server.

43. The computer program product of claim 41 wherein said assignment unit comprises:
computer readable code configured to cause a computer to determine a first server;
computer readable code configured to cause a computer to determine a number of clients said first server is currently serving;
computer readable code configured to cause a computer to select a second server if said number is greater than a threshold for said first server.

44. The computer program product of claim 43 wherein said second server must serve as said primary server.

45. The computer program product of claim 43 wherein said computer readable code configured to cause a computer to select comprises:
computer readable code configured to cause a computer to determine a status of said second server.

46. The computer program product of claim 45 wherein said status comprises:
a first number wherein said first number is the number of clients said second server serves as a first primary server; and
a second number wherein said second number is a client capacity of said second server.

47. The computer program product of claim 45 wherein said status further comprises:
a third number wherein said third number is the number of client said second server serves as an alternate server.

48. The computer program product of claim 45 wherein said computer readable code configured to cause a computer to determine said status comprises:
computer readable code configured to cause a computer to receive a plurality of status updates from said plurality of servers.

49. The computer program product of claim 41 further comprising:
computer readable code configured to cause a computer to assign an alternate server from said plurality of servers.

50. The computer program product of claim 49 wherein said computer readable code configured to cause a computer to assign said alternate server is further configured to cause said primary server to assign said alternate server based on a status of said alternate server.

51. The computer program product of claim 49 further comprising:
computer readable code configured to cause a computer to reassign said alternate server as a new primary server and selecting a new alternate server if said primary server becomes unavailable and said client makes a request.

52. The computer program product of claim 51 further comprising:
computer readable code configured to cause a computer to remove said client from a list of clients served by said primary server.

53. The computer program product of claim 52 wherein said list is maintained in said primary server.

54. The computer program product of claim 53 wherein said computer readable code configured to cause a computer to remove is further configured to perform when said primary server becomes available.

55. The computer program product of claim 41 further comprising:
computer readable code configured to cause a computer to maintain a first cache of data items on said client; and
computer readable code configured to cause a computer to mirror said first cache in a second cache on said primary server.

56. The computer program product of claim 55 further comprising:
computer readable code configured to cause a computer to mirror said first cache in a third cache on an alternate server.

57. The computer program product of claim 55 further comprising:
computer readable code configured to cause a computer to retrieve a first data item from a data source wherein said retrieval unit is located in said primary server; and
computer readable code configured to cause a computer to instruct said client to use a second data item wherein said second data item is in said first cache if said first data item is equal to a copy of said second data item in said second cache.

58. The computer program product of claim 55 further comprising:
computer readable code configured to cause a computer to calculate a first value from a first data item using a correction method wherein said first data item is in said first cache;
computer readable code configured to cause a computer to transmit said first value from said client to said primary server;
computer readable code configured to cause a computer to retrieve a second data item from a data source wherein said retrieval unit is located in said primary server;
computer readable code configured to cause a computer to calculate a second value from said second data item using said correction method; and
computer readable code configured to cause a computer to instruct said client to use said first data item if said second value is equal to said first value.

59. The computer program product of claim 58 wherein said computer readable code configured to cause a computer to instruct comprises:
computer readable code configured to cause a computer to store said second data item in said second cache.

60. The computer program product of claim 58 wherein said correction method is a cyclic redundancy code.
